(19) United States
(12) Patent Application Publication
(10) Pub. No.: US 2014/0339297 A1
(43) Pub. Date: Nov. 20, 2014

(54) SYSTEM FOR WRITING RFID TAGS

(71) Applicant: Checkpoint Systems, Inc., Thorofare, NJ (US)

(72) Inventor: Peter BREMER, Beerfelden (DE)

(73) Assignee: Checkpoint Systems, Inc., Thorofare, NJ (US)

(21) Appl. No.: 14/278,089

(22) Filed: May 15, 2014

(30) Foreign Application Priority Data
May 15, 2013 (DE) 20 2013 004 511.6

(51) Int. Cl. G06K 1/14; G06K 1/12

(52) U.S. Cl. CPC G06K 1/14; G06K 1/128
USPC 235/375

(57) ABSTRACT

A system for writing RFID tags of a set of piece goods transported by a conveyor along a conveying path, with a reading device for reading the RFID tags during transport along the conveying path, with a first writing device for writing the RFID tags with data during transport along the conveying path, with a circuit, which is connected to the reading device and to the first writing device. The circuit is configured to assign identifiers, read by the reading device of each RFID tag to the set, whereby the RFID tag is attached to an item of the set. The circuit is configured to form a first subset of the set. The circuit is configured to send the identifiers, associated with the first subset, to the first writing device to write the data to the RFID tags of the first subset via the first writing device.

This nonprovisional application claims priority under 35 U.S.C. §119(a) to German Patent Application No. 20 2013 004 511.6, which was filed in Germany on May 15, 2013, and which is herein incorporated by reference.

### BACKGROUND OF THE INVENTION

1. Field of the Invention

The present invention relates to a system for writing RFID tags.

2. Description of the Background Art

DE 698 26 284 T2, which corresponds to U.S. Pat. Nos. 6,693,539, 5,963,134, and 6,195,006, which are all herein incorporated by reference, and which disclose an inventory control system for articles which are maintained in a storage area. An RFID tag, which can also be called a radio frequency tag, is attached to each article. Each RFID tag has an antenna for use in detecting the presence of the article by receiving an interrogation signal and returning a response signal. Each RFID tag has an integrated circuit, connected to the antenna, for storing article identification information and for outputting the article identification information with the response signal upon interrogation of the RFID tag. The system has an article return area for receiving articles. The article return area has an interrogation zone through which the articles are passed.

In the clothing industry, items of clothing of different types, shape, size, color, or the like are generally collected, for example, in an order. This occurs, for example, immediately after the sewing and ironing of the clothing items or, for example, from a collection warehouse in which the same items of clothing are grouped and stored in an organized manner. For example, 10 blue jackets, 10 black jackets, 3 gray pants, and 4 pants of a different style are ordered with a purchase order by a customer. For the mechanical handling of these sorting and distribution tasks, sorting devices, so-called sorters, are known which are equipped with electronic detection devices and electronically controlled switching devices. These sorting devices can log the clothing items hanging one behind the other on clothes hangers during transport and transport the hangers by means of a conveyor, e.g., on a track system, in which electronically switchable gate devices are built at specific places of a conveying path. A specific gate is opened by a circuit preprogrammed based on the logging, when a specific electronically identified clothing item is located in the gate space. The hanger with the particular clothing item leaves the hanger series through the gate and, for example, reaches a collecting track on which a collection order is collected for dispatching. WO 93/03985 discloses a method and a device for sorting goods hanging on hangers.

U.S. Pat. No. 7,336,167 B2 discloses a system and method for interrogating RFID tags, which is carried out during rotation of cargo on a pallet. The rotation and reading process are continued until all RFID tags on the pallet have been read.

### SUMMARY OF THE INVENTION

It is therefore an object of the invention to improve a system for writing RFID tags.

Accordingly, a system is provided for writing RFID tags of a set of piece goods transported along a conveying path via a conveyor.

The system has a reading device for reading the RFID tags during transport along the conveying path. The reading device is preferably designed as a so-called reader and is set up preferably exclusively for reading RFID tags. Writing (encoding) of the RFID tags, in contrast, preferably does not occur by the reading device.

The system has a first writing device for writing the RFID tags with data during transport along the conveying path. Writing can also be called encoding.

The system has a circuit. The circuit can be connected to the reading device and to the first writing device. Each connection is, for example, an electrical connection via a cable or network such as, for example, a LAN or wirelessly, for example, via a WLAN.

The reading device and the first writing device are arranged distanced from one another on the conveying path. Preferably, the reading device and the first writing device have a distance of at least two meters to one another. If the distance is less than this, the reading device and the first writing device can be separated by a shielding device.

The circuit can be configured to assign to the set the identifier, read by the reading device, of each RFID tag attached to an item in the set, particularly by means of a set identification. With the assignment the circuit can be configured to determine the final code for writing the RFID tag.

The circuit can be configured to form a first subset of the set. The system can be configured to form the first subset dynamically. For example, the first subset can be created based on the number of elements in the set, for example, as a fraction of the same.

The circuit is configured to send the identifiers, associated with the first subset, to the first writing device in order to write the data to the RFID tags of the first subset by means of the first writing device.

A variety of advantages are achieved by the specific implementation of the system. By dividing the reading processes and the writing processes to the separated reading device and writing device, a transport speed can remain high and need not be reduced in order to read and write all tags reliably. The modularity due to the division into a reading device and first writing device makes it possible that the system can easily be installed into already existing conveyor systems as well, without having to substantially change the conveyor system.

According to an exemplary embodiment, the writing processes can be divided among a plurality of writing devices.

According to an exemplary embodiment, the system can have a second writing device for writing the RFID tags with data during transport along the conveying path. In this regard, the second writing device is different from the first writing device.

According to an exemplary embodiment, the circuit can be connected to the second writing device. The connection is, for example, an electrical connection via a cable or network such as, for example, a LAN or wirelessly, for example, via a WLAN.

According to an advantageous refinement, the first writing device and the second writing device cam be arranged distanced from one another on the conveying path. The first writing device and the second writing device can have a distance of at least two meters to one another. If the distance is less than this, the first writing device and the second writing device can be separated by a shielding device.

According to an exemplary embodiment, the circuit can be configured to form a second subset of the set from the RFID tags that were not written in the first writing device.

According to an exemplary embodiment, the circuit is configured to send the identifiers, associated with the second subset, to the second writing device in order to write the data to the RFID tags of the second subset via the second writing device.

A variety of advantages is likewise achieved by an implementation of the system according to the aforementioned exemplary embodiments. By dividing the writing processes to a plurality (at least two) of writing devices, even at a high tag density the transport speed can remain high and need not be reduced in order to write to all tags reliably. The modularity due to the division into a first writing device and second writing device makes it possible to install the system easily into already existing conveyor systems, without having to change the conveyor system substantially. Moreover, a high conveying speed can be achieved.

According to an exemplary embodiment, the reading device has a reading zone through which the conveying path passes in order to move through each item with RFID tags via the conveyor. The reading zone can be configured within a housing of the reading device. The housing can have an electrically conductive material. Advantageously, the electrically conductive material of the housing has shielding properties.

According to an exemplary embodiment, the first writing device can have a first writing zone traversed by the conveying path in order for each item with RFID tags to move through by means of the conveyor. The first writing zone can be configured within a housing of the first writing device. Preferably, the housing has an electrically conductive material. Advantageously, the electrically conductive material of the housing can have shielding properties.

According to an exemplary embodiment, the second writing device can have a second writing zone through which the conveying path passes in order to move through each item with RFID tags by means of the conveyor. Preferably, the second writing zone is configured within a housing of the second writing device. The housing can have an electrically conductive material. Advantageously, the electrically conductive material of the housing can have shielding properties.

According to an exemplary embodiment, the reading device can have an entry opening and an exit opening for carrying the piece goods along the conveying path. The reading device can be configured for setting a height and/or width of the entry opening and/or exit opening. Preferably, the entry opening and/or exit opening are limited by the electrically conductive material of the housing of the reading device. Advantageously, the electrically conductive material of the housing has shielding properties.

According to an exemplary embodiment, the reading device can have a shielding device which is formed adjacent to the entry opening and/or to the exit opening. The shielding device is preferably a passive device without electrical units for communicating with the tags.

According to an exemplary embodiment, the conveying path can pass through the shielding device.

According to an exemplary embodiment, the first writing device can be configured to write the data to the RFID tags of the first subset sequentially based on a predetermined sequence of the identifiers of the first subset.

According to an exemplary embodiment, the second writing device can be configured to write the data to the RFID tags of the second subset sequentially based on a predetermined sequence of the identifiers of the second subset.

According to an exemplary embodiment, the RFID tags can be incorporated in clothing items as piece goods. The RFID tags can be made as so-called soft tags or hard tags.

According to an exemplary embodiment, the circuit can be configured to send the identifiers and the data to the first writing device and/or to the second writing device based on a succession of a plurality of sets.

A further aspect provides a method for writing RFID tags of a set of piece goods transported via a conveyor along a conveying path. For example, a system for carrying out an operation of the process is set up. The method can have the following steps: reading the RFID tags during the transport along the conveying path by means of a reading device; assigning each identifier, read by the reading device, of each RFID tag to a set, particularly to a set identification of the set, whereby in particular each tag is attached to an item of the set; forming a first subset of the set; sending the identifiers, associated with the first subset, to a first writing device; and/or writing the data to the RFID tags of the first subset by means of the first writing device.

According to an exemplary embodiment, the method can have the additional steps of: forming a second subset of the set from the RFID tags that were not written in the first writing device; sending the identifiers, associated with the second subset, to a second writing device; and/or writing the data to the RFID tags of the second subset by means of the second writing device.

The method can be implemented, for example, as program code. In this case, the program code of the method is executable on a processor.

The previously described refinement variants are especially advantageous both individually and in combination. In this regard, all refinement variants can be combined with one another. Some possible combinations are explained in the description of the exemplary embodiments shown in the figures. These possible combinations of the refinement variants depicted therein are not definitive, however.

Further scope of applicability of the present invention will become apparent from the detailed description given hereinafter. However, it should be understood that the detailed description and specific examples, while indicating preferred embodiments of the invention, are given by way of illustration only, since various changes, combinations and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic view of a system;

FIG. 2 is a further schematic view of a system; and

FIG. 3 is a schematic diagram of a process.

### DETAILED DESCRIPTION

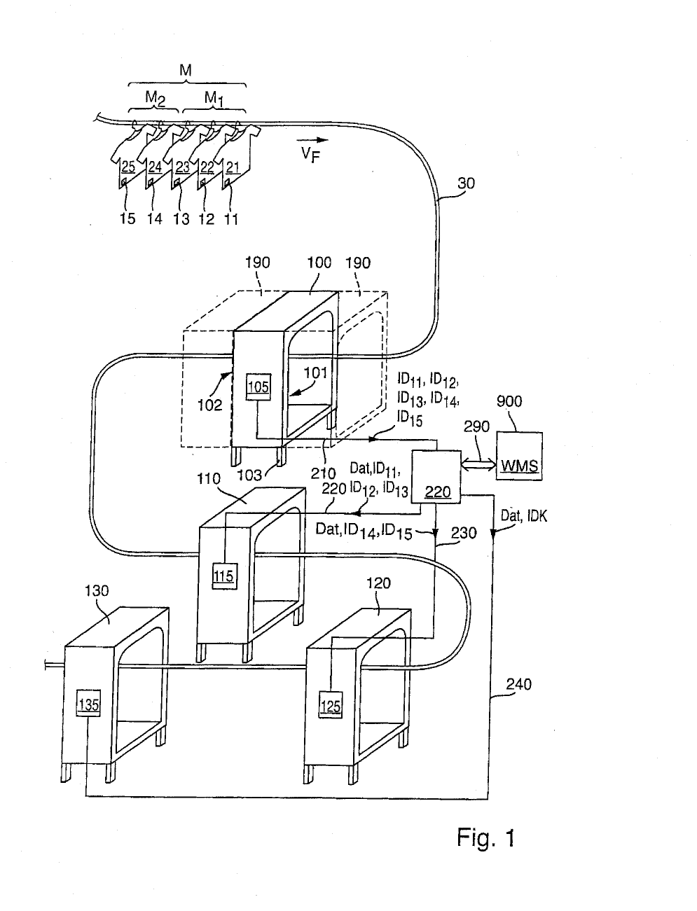

A conveying system is shown in FIG. 1, which transports clothing items 21, 22, 23, 24, 25 as piece goods along conveying path 30. Only five clothing items 21, 22, 23, 24, 25 are shown in FIG. 1 for greater clarity. However, in a specific implementation the number of clothing items 21, 22, 23, 24, 25 in a set M can be much higher. Such systems are used, for example, by textile manufacturers or textile wholesalers. Items 21, 22, 23, 24, 25 are conveyed continuously in this case. Such a conveyor can also be called a continuous conveyor. FIG. 1 shows clothing items 21, 22, 23, 24, 25 hung on hangers and transported by means of a track along conveying path 30. A high transport speed VF is thereby needed to keep the costs low.

In the clothing industry, clothing items of the same type, shape, height, color, etc., are generally produced, for example, in the set M. For manufacturing, the clothing items are, for example, sewn and ironed. Each clothing item 21, 22, 23, 24, 25 is assigned precisely one RFID tag. The RFID tag is attached to the assigned clothing item 21, 22, 23, 24, 25, in that the RFID tag, for example, is part of a sewn-in label or is sewn separately into a seam. The clothing items 21, 22, 23, 24, 25 provided with the RFID tags in the exemplary embodiment of FIG. 1 are hung on hangers and the hangers are moved by the conveyor system, e.g., on a track system.

Shown by way of example in FIG. 1 are five clothing items 21, 22, 23, 24, 25 of the set M, all of which are manufactured identically. Each RFID tag 11, 12, 13, 14, 15 attached to clothing items 21, 22, 23, 24, 25 is preprogrammed, whereby, e.g., the manufacturer's data are stored in RFID tag 11, 12, 13, 14, 15. Likewise, each RFID tag 11, 12, 13, 14, 15 has an identifier ID11, ID12, ID13, ID14, ID15, which is programmed, for example, in RFID tag 11, 12, 13, 14, 15. Alternatively, the serial number of RFID tag 11, 12, 13, 14, 15 can also be used as identifier ID11, ID12, ID13, ID14, ID15.

In the exemplary embodiment of FIG. 1, the system has a reading device 100 for reading RFID tags 11, 12, 13, 14, 15. Reading device 100 has a number of feet 103 with an adjustable height in order to adjust the position of reading device 100 to the conveyor, particularly to its overall height. The housing of reading device 100 has an electrically conductive material, such as, for example, sheet metal or aluminum. The conductive material achieves a shielding property of the housing.

In the exemplary embodiment of FIG. 1, reading device 100 has an entry opening 101 and an exit opening 102, which form a passage through which conveying path 30 passes. Reading device 100 is configured to adjust a height and/or a width of entry opening 101 and/or exit opening 102 for different sizes of the piece goods. The system is configured so that reading device 100 reads RFID tags 11, 12, 13, 14, 15 preferably exclusively. Writing RFID tags 11, 12, 13, 14, 15, which can also be called encoding, in contrast, is preferably not carried out by reading device 100.

Because of the high transport speed VF it must be assured that the greatest possible number of RFID tags 11, 12, 13, 14, 15 of set M is read. Reading device 100 is optimized for the reading process. In this regard, clothing items 21, 22, 23, 24, 25 of set M are typically transported closely one behind the other, resulting in a high density of RFID tags 11, 12, 13, 14, 15 in a reading zone of reading device 100. Because reading processes are shorter in time than writing processes, reading of RFID tags 11, 12, 13, 14, 15 at a high tag density can be carried out in a relatively small section of conveying path 30 during transport along conveying path 30.

If a high collision rate occurs during the reading process, the distance to the further RFID tags, for example, of a preceding or succeeding set can be increased. In the exemplary embodiment of FIG. 1, however, a shielding device 190 is provided at entry opening 101 and exit opening 102, which significantly reduces the number of RFID tags detectable by the reading device and thus also greatly reduces the collision rate. A housing of shielding device 190 has an electrically conductive material for shielding. Shielding device 190 also has a passage zone through which conveying path 30 passes.

Reading device 100 is connected via a connection 210 to a circuit 200. Circuit 200 is, for example, a computer, which is connected via a LAN connection 210 to reading device 100. Identifiers ID11, ID12, ID13, ID14, ID15 of read RFID tags 11, 12, 13, 14, 15 can be transmitted to circuit 200 via connection 210. Reading device 100 has a control unit 105 that controls the reading process and the communication via connection 210 with circuit 200.

Circuit 200 is configured to assign each identifier ID11, ID12, ID13, ID14, ID15, read by reading device 100, of each RFID tag 11, 12, 13, 14, 15 to the set M. Clothing items 21, 22, 23, 24, 25 that are elements of the set M are thereby acquired computationally. Moreover the set M is assigned data Dat. These data Dat describe the properties of clothing items 21, 22, 23, 24, 25 of set M, for example, their type, size, color, or the like.

The system has a first writing device 110 for writing RFID tags 11, 12, 13, 14, 15 with the data Data First writing device 110 is arranged distanced from reading device 100 at least in the conveying direction. The minimum distance is two meters. The greater the distance between first writing device 110 and reading device 100, the smaller the interferences. If the distance is less than the minimum distance, first writing device 110 and reading device 100 are separated from one another by a shielding device (190) of sufficient length. Writing device 110 is optimized for the writing process for writing RFID tags 11, 12, 13, 14, 15. First writing device 110 has a control unit 115, which controls the writing process and the communication via a connection 220 to circuit 200.

Circuit 200 is configured to form a first subset M1 of set M. For example, the three clothing items 21, 22, 23 and thereby the associated three RFID tags 11, 12, 13 and thereby the associated three identifiers ID11, ID12 and ID13 are assigned to first subset M1. Circuit 200 is configured to send identifiers ID11, ID12, ID13, associated with first subset M1, to first writing device 110. To this end, first writing device 110 is connected to circuit 200 via connection 220.

In addition to identifiers ID11, ID12, ID13 of first subset M1, the data Dat are transmitted from circuit 200 to first writing device 110 in order to write the data Dat to RFID tags 11, 12, 13 of first subset M1 by means of first writing device 110. The writing process can thereby occur during the transport of clothing items 21, 22, 23, 24, 25 along conveying path 30, because not all RFID tags 11, 12, 13, 14, 15 of set M are written during the movement of RFID tags 11, 12, 13, 14, 15 through a first writing zone of first writing device 110.

RFID tags 11, 12, 13 to be written can be interrogated selectively (individually) by means of identifiers ID11, ID12, ID13. An increased writing speed or an especially large-dimensioned first writing device 110 is not necessary because of the reduced number of elements of first subset M1 and the direct interrogation of RFID tags 11, 12, 13 of first subset M1. Writing each RFID tag 11, 12, 13 of first subset M1 is reported back via connection 210 to circuit 200.

A second writing device 120 is arranged distanced from first writing device 110 along conveying path 30. In this regard, first writing device 110 and second writing device 120 are arranged distanced from one another on conveying path 30. First writing device 110 and second writing device 120 are made the same. Circuit 200 is also connected to second writing device 120 via a connection 230. Second writing device 120 has a control unit 125 that controls the writing process and the communication via connection 230 to circuit 200.

Circuit 200 is configured to form a second subset M2 of set M from RFID tags 14, 15 not written in first writing device 110. Second subset M2 is thereby disjunctive to first subset M1, if all RFID tags 11, 12, 13 of first subset M1 were written. If, in contrast, the writing of an RFID tag 11, 12, 13 of first subset M1 has failed, the writing process for this RFID tag can be repeated by second writing device 120. The number of unwritten or incorrectly written RFID tags can so be significantly reduced.

Circuit 200 is configured to send identifiers ID14, ID15, associated with second subset M2, to second writing device 120 via connection 230. In addition to identifiers ID14, ID15 of second subset M2, the data Dat of circuit 200 are transmitted to second writing device 120 in order to write the data Dat to RFID tags 14, 15 of second subset M2 by means of second writing device 120. The writing of RFID tags 14, 15 by second writing device 120 occurs also during the transport of clothing items 21, 22, 23, 24, 25 along conveying path 30. The transport along conveying path 30 need therefore not be halted either for the reading process or for the writing process.

Writing devices 110 and 120 can be positioned almost arbitrarily along conveying path 30. A change in conveying path 30 is necessary only in exceptional cases. In the case of a change of conveying path 30, the position of reading and writing devices 100, 110, 120 can be easily adjusted. The conveying speed VF can be retained unchanged due to the division of the writing processes to a plurality of independent writing devices 110, 120.

As a departure from the exemplary embodiment of FIG. 1, set M can be divided into a greater number of subsets in case of a very high density of RFID tags. In an exemplary embodiment of FIG. 1, a third writing device 130 with a control unit 135 is provided in addition. Control unit 135 is also connected to circuit 200 via a connection 240. Third writing device 130 is arranged distanced from second writing device 120 to reduce malfunctions. The RFID tags the writing process of which failed earlier in the first or second writing device 110, 120 can be written by third writing device 130. Accordingly, the identifier IDK of the associated RFID tag is transmitted from circuit 200 to third writing device 130. If the RFID tag cannot be written in third writing device 130 either, an error report is output for identifier IDK.

Circuit 200 in an exemplary embodiment of FIG. 1 is connected with an interface 290 to a warehouse management system 900 (WMS). Data sets associated with the writing processes can be transmitted via interface 290 to warehouse management system 900 for further processing, for example, for mechanical sorting and distribution activities by means of a sorting device, a so-called sorter.

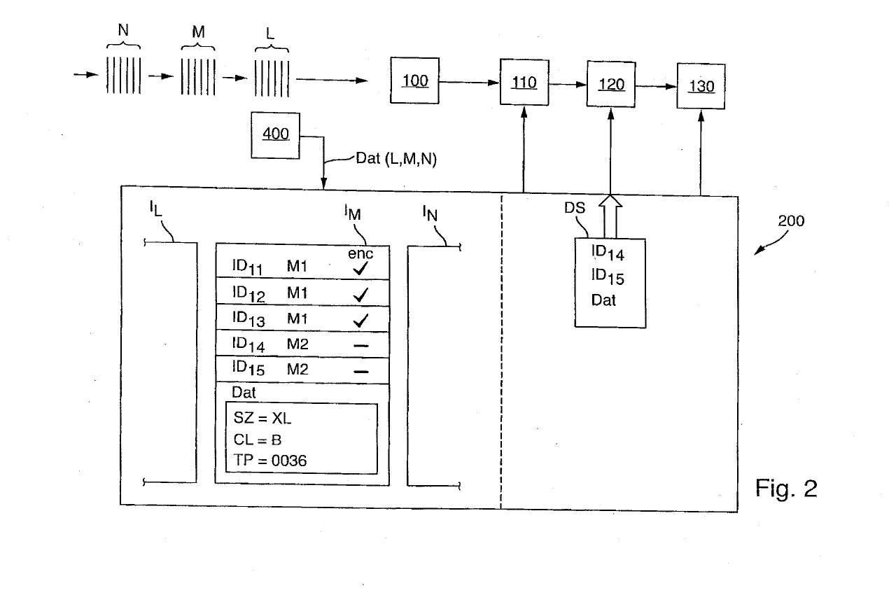

FIG. 2 shows schematic functions of circuit 200. Data sets, for example, in the form of tables, for the sets L, M, and N are stored in the memory of circuit 200. Each table has an identification IL, IM, IN (the table name or meta tag) associated with set L, M, N. Each data set contains data Dat, which describe each piece of the set L, M, N. The data Dat are, for example, the size SZ, color CL, or type TP of the clothing items of the specific set. The data Dat are input into the system manually or automatically, for example, via an input device 400 and stored in circuit 200.

The table also contains the identifiers ID11, ID12, ID13, ID14, ID15 of all RFID tags of the set M. Each identifier ID11, ID12, ID13, ID14, ID15 is assigned to a subset M1, M2. The situation in which RFID tags 11, 12, 13 of first subset M1 have already been written is shown in FIG. 2. Accordingly, a data set DS with the identifiers ID14, ID15 of second subset M2 and with the data Dat is output to second writing device 120.

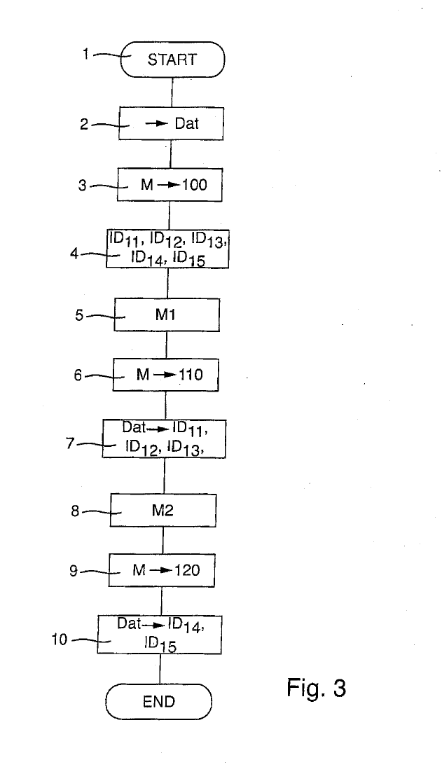

FIG. 3 shows an exemplary embodiment of a process in a schematic diagram. The system is turned on and started up in a first step 1. In the next second step 2 the data Dat is read in for a set M of clothing items. In the following third step 3, the items of set M are identified in a reading device 100, in that reading device 100 reads, for example, continuously and RFID tags that have not yet been read are identified by the system. Alternatively, a special component (for example, manual input, scanner, etc.) for identifying the set M can be provided.

In the fourth step 4 identifiers ID11, ID12, ID13, ID14, ID15 are determined by reading the RFID tags. All read identifiers ID11, ID12, ID13, ID14, ID15 belong to set M.

In the fifth step 5, based on the set M a first subset M1 with a number of associated identifiers ID11, ID12, ID13 is formed and the identifiers ID11, ID12, ID13 of the first subset M1 are transmitted to a first writing device 110. If in the sixth step 6 it is determined that the items in set M have reached first writing device 110, in the following seventh step 7 the data Dat are written to the RFID tags associated with identifiers ID11, ID12 ID13 of first subset M1.

In the eighth step 8, a second subset M2 with a number of associated identifiers ID14, ID15 is formed and identifiers ID14, ID15 of second subset M2 are transmitted to a second writing device 120. If in the ninth step 9 it is determined that the items in set M have reached second writing device 120, in the following tenth step 10 the data Dat are written to the RFID tags associated with identifiers ID14, ID15 of second subset M2.

The invention is not limited to the shown embodiment variants in FIGS. 1 through 3. For example, it is possible to use a greater number of writing devices or a plurality of reading devices. It is also possible to set the first subset M1 equal to the set M and to assign to the second subset M2 the RFID tags that have not been written after the feedback by the first writing device. Preferably, the first subset is a first true subset. Preferably, the second subset is a second true subset. The functionality of the system according to FIG. 1 can be used especially advantageously for an electronic identification of textiles. The solution according to FIG. 1 can also be used in all other conveying systems such as, for example, rollers or the like. The items of the piece goods can be conveyed open or in a transport container (cardboard box).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A system for writing RFID tags of a set of piece goods that are transported via a conveyor along a conveying path, the system comprising:
a reading device for reading the RFID tags during transport thereof along the conveying path;
a first writing device for writing data to the RFID tags during transport along the conveying path;
a circuit that is connected to the reading device and to the first writing device, the reading device and the first writing device being arranged at a distance from one another along the conveying path,
wherein the circuit is configured to assign identifiers, which are read via the reading device, of each RFID tag to the set, the RFID tag being attached to an item of the set,
wherein the circuit is configured to form a first subset of the set, and
wherein the circuit is configured to send the identifiers, which are associated with the first subset, to the first writing device in order to write the data to the RFID tags of the first subset via the first writing device.

2. The system according to claim 1, further comprising:
a second writing device for writing the RFID tags with data during transport along the conveying path,
wherein the circuit is connected to the second writing device, the first writing device and the second writing device being arranged at a distance from one another along the conveying path,
wherein the circuit is configured to form a second subset of the set from the RFID tags that were not written in the first writing device, and
wherein the circuit is configured to send the identifiers, associated with the second subset, to the second writing device in order to write the data to the RFID tags of the second subset via the second writing device.

3. The system according to claim 2, wherein the reading device has a reading zone through which the conveying path passes in order to move through each item with RFID tags via the conveyor, and/or wherein the first writing device has a first writing zone through which the conveying path passes in order to move through each item with RFID tags via the conveyor, and/or wherein the second writing device has a second writing zone through which the conveying path passes in order to move through each item with RFID tags via the conveyor.

4. The system according to claim 1, wherein the reading device has an entry opening and an exit opening for carrying the piece goods along the conveying path, wherein the reading device has a shielding device that is formed adjacent to the entry opening and/or to the exit opening, and wherein the conveying path passes through the shielding device.

5. The system according to claim 2, wherein the first writing device is configured to write the data to the RFID tags of the first subset sequentially based on a predetermined sequence of identifiers of the first subset, and/or wherein the second writing device is configured to write the data to the RFID tags of the first subset sequentially based on a predetermined sequence of identifiers of the second subset.

6. The system according to claim 1, wherein the RFID tags are incorporated in clothing items as the piece goods.

7. The system according to claim 2, wherein the circuit is configured to send the identifiers and the data to the first writing device and/or to the second writing device based on a succession of a plurality of sets.

8. A system for writing to RFID tags of a set of piece goods transported by a conveyor along a conveying path, the system configured to perform the functions:
reading the RFID tags during transport along the conveying path by a reading device;
assigning each identifier, read by the reading device, of each RFID tag to the set or to a set identification of the set, each RFID tag being attached to an item of the set;
forming a first subset of the set;
sending the identifiers associated with the first subset to a first writing device; and
writing the data to the RFID tags of the first subset via the first writing device.

9. The system according to claim 8, further comprising:
forming a second subset of the set from the RFID tags that were not written in the first writing device,
sending the identifiers associated with the second subset to a second writing device; and
writing the data to the RFID tags of the second subset via the second writing device.

10. A method for writing RFID tags of a set of piece goods transported by a conveyor along a conveying path, the method comprising:
reading the RFID tags during transport along the conveying path by a reading device;
assigning each identifier read by the reading device of each RFID tag to the set or to a set identification of the set, each tag being attached to an item of the set;
forming a first subset of the set;
sending the identifiers, associated with the first subset, to a first writing device, and
writing the data to the RFID tags of the first subset via the first writing device during transport along the conveying path.

11. The method according to claim 10, further comprising:
forming a second subset of the set from the RFID tags that were not written in the first writing device;
sending the identifiers associated with the second subset to a second writing device; and
writing the data to the RFID tags of the second subset via the second writing device.
